(19) United States
(12) Patent Application Publication
(10) Pub. No.: US 2008/0149602 A1
(43) Pub. Date: Jun. 26, 2008

(54) WELDING AND PLASMA CUTTING METHOD AND SYSTEM

(75) Inventors: Jeff Lenzner, Appleton, WI (US); Ronald D. Woodward, Kaukauna, WI (US); Kenneth A. Stanzel, Appleton, WI (US)

Correspondence Address: FLETCHER YODER (ILLINOIS TOOL WORKS INC.), P.O. BOX 692289, HOUSTON, TX, 77269-2289, US

(73) Assignee: ILLINOIS TOOL WORKS INC., Glenview, IL (US)

(21) Appl. No.: 11/947,762

(22) Filed: Nov. 29, 2007

Related U.S. Application Data
(60) Provisional application No. 60/876,840, filed on Dec. 22, 2006.

(51) Int. Cl. B23K 9/00

(52) U.S. Cl. 219/121.45

(57) ABSTRACT

A system, in some embodiments, includes a multi-torch power supply. The power supply has a first circuit configured to control output to a first electrical torch, and a second circuit configured to control output to a second electrical torch. The power supply also has a power source configured to supply power to the first and second circuits to enable both independent and simultaneous operation of the first and second electrical torches.

### CROSS-REFERENCE TO RELATED APPLICATION

This application claims priority to provisional application No. 60/876,840 filed on Dec. 22, 2006, which is hereby incorporated by reference.

### BACKGROUND

The invention relates generally to electrical torches, such as arc welding torches and plasma cutting torches.

In general, electrical torches receive power from standalone units, each with an independent power supply and control circuitry. For example, an arc welding system is generally separate and independent from a plasma cutting system. Each system has different power requirements and operational characteristics, which results in a different power supply for the particular type of torch. Some procedures require the use of a variety of different electrical torches, such as an arc welding torch and a plasma cutting torch. As a result, these systems must be purchased or leased as separate standalone units at a significant cost. Furthermore, these systems must be transported, set up, and operated completely independent from one another. All of these factors increase costs and reduce efficiency of various procedures involving use of the different systems.

### BRIEF DESCRIPTION

A system, in some embodiments, includes a multi-torch power supply. The power supply has a first circuit configured to control output to a first electrical torch, and a second circuit configured to control output to a second electrical torch. The power supply also has a power source configured to supply power to the first and second circuits to enable both independent and simultaneous operation of the first and second electrical torches.

### DRAWINGS

These and other features, aspects, and advantages of the present invention will become better understood when the following detailed description is read with reference to the accompanying drawings in which like characters represent like parts throughout the drawings, wherein:

FIG. 1 is a diagram of an exemplary system having a multi-torch power supply in accordance with certain embodiments of the present technique;

FIG. 2 is a diagram of another exemplary system having a multi-torch power supply in accordance with certain embodiments of the present technique;

FIG. 3 is a diagram of exemplary plasma cutter circuitry and welder circuitry of the multi-torch power supply as illustrated in FIGS. 1 and 2 in accordance with one embodiment of the present technique; and

FIG. 4 is a diagram of another embodiment of plasma cutter circuitry and welder circuitry of the multi-torch power supply as illustrated in FIGS. 1 and 2.

### DETAILED DESCRIPTION

As discussed in detail below, various torch systems are integrated together in a single chassis using a single power supply, thereby reducing costs, weight, and space consumption of the torch systems. For example, welding torches, cutting torches, or other torches may all be coupled to the single power supply, wherein each torch can receive power on-demand in response to a signal from the torch (e.g., a trigger signal). In other words, each torch may be without power (e.g., cold state) until a user wishes to operate the torch, and then the user may engage a trigger on the torch to command the single power supply to automatically transmit power to the torch (e.g., hot state). In some embodiments, the various torches can operate simultaneously using the single power supply. In other embodiments, operation of one torch may lockout operation of the other torch, and vice versa.

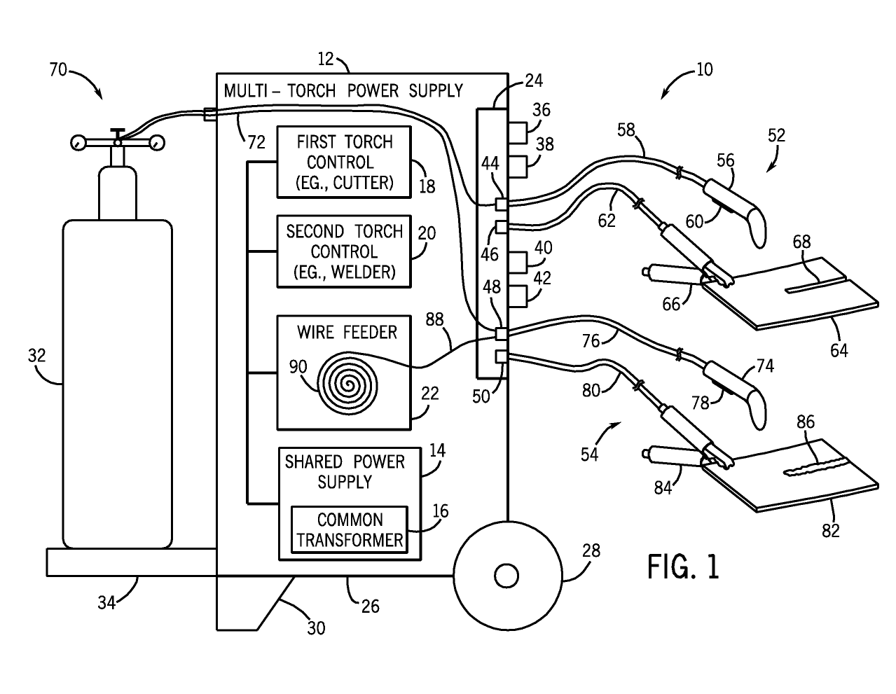

FIG. 1 is a diagram of an exemplary system 10 having a multi-torch power supply 12 in accordance with certain embodiments of the present technique. As illustrated, the multi-torch power supply 12 includes a shared power supply 14 having a common transformer 16, which is used to supply power to a plurality of different torches alone or in combination with one another. In some embodiments, the shared power supply 14 may have a plurality of elements, such as transformer windings, that may be used alone or in combination with one another for various torches. In other words, the shared power supply 14 does not necessary have a single or common transformer 16, but rather an independent transformer 16 and/or other elements may be dedicated to each torch. As discussed in further detail below, the shared power supply 14 may provide the same or different power levels to one or more torches at the same or different times on-demand by the particular torch. Thus, a user operating a torch with the multi-torch power supply 12 can automatically obtain the desired power from one or more power sources, e.g., a single source, without requiring any manual switching. In the illustrated embodiment, the multi-torch power supply 12 also includes a first torch control 18, a second torch control 20, a wire feeder 22, and a user control panel 24 coupled to the shared power supply 14. These components 14, 18, 20, 22, and 24 are all disposed in a single or common chassis 26, which also may include a pair of wheels 28 and a base support 30 to facilitate movement around the desired work area. Furthermore, the multi-torch power supply 12 may include one or more gas cylinders 32 (e.g., argon, carbon dioxide, etc.) disposed on a cylinders support 34.

In the illustrated embodiment, the first torch control 18 may include a variety of cutting torch controllers or circuitry, while the second torch control 20 may include a variety of welding torch controllers or circuitry. For example, the first torch control 18 may include various controllers or circuitry for plasma arc cutting (PAC), air arc gouging (AAG), plasma arc gouging (PAG), and so forth. The second torch control 20 may include various controller and circuitry for metal inert gas (MIG) welding, tungsten inert gas (TIG) welding, plasma arc welding (PAW), shielded metal arc welding (SMAW), and so forth. Thus, the first and second torch controls 18 and 20 may include controls for gas flow, current, voltage, wire feed rate, temperature feedback, torch trigger feedback, and other suitable inputs and outputs. In cooperation with these controls 18 and 20, the user control panel 24 includes a variety of inputs 36, 38, 40, and 42 and outputs or connectors 44, 46, 48, and 50. The user inputs 36, 38, 40, and 42 may include current controls, voltage controls, wire feed rate, gas flow, and so forth.

The system 10 of FIG. 1 also includes a plurality of torches coupled to the user control panel 24. For example, a first torch assembly 52 is coupled to the first torch control 18 via the user control panel 24, while a second torch assembly 54 is coupled to the second torch control 20 via the user control panel 24. The illustrated assembly 52 includes a first torch 56 coupled to the connector 44 via a supply cable 58, wherein the first torch 56 includes a trigger 60 configured to actuate the torch 56 and obtain power from the shared power supply 14 on-demand via the first torch control 18. The assembly 52 also includes a work cable 62 coupled to the connector 46 and to a work piece 64 via a ground clamp 66.

In operation, current flows from the multi-torch power supply 12 (e.g., shared power supply 14) through the supply cable 58 into the first torch 56, where an arc is formed between the first torch 56 and the work piece 64. The current then returns through the work cable 62 back to the multi-torch power supply 12. In this manner, the arc heats up the work piece 64 in a focused area to enable cutting as illustrated by cut 68 in the work piece 64. In addition, in the illustrated embodiment, gas may be supplied from the gas cylinder 32, out through gas controls 70, along a gas line 72, into the supply cable 58, and through the first torch 56 in a direction toward the work piece 64. In a typical plasma arc cutting procedure, a high velocity stream of the compressed gas expels the molten material from the work piece 64 after the work piece 64 is heated up by the arc formed between the torch 56 and the work piece 64. Although plasma arc cutting is one embodiment that may be used with the multi-torch power supply 12 of FIG. 1, the system 10 may be configured for a variety of other cutting torches within the scope of the present technique.

Similar to the first torch assembly 52, the illustrated second torch assembly 54 includes a second torch 74 coupled to the connector 48 via a supply cable 76, wherein the second torch 74 includes a trigger 78 configured to initiate operation of the torch 74 and obtain power from the multi-torch power supply 12 automatically on-demand when desired for a particular operation. The illustrated assembly 54 also includes a work cable 80 coupled to the connector 50 and a work piece 82 via a work clamp 84. Again, similar to the first torch assembly 52, the second torch assembly 54 forms a closed circuit or current path between the multi-torch power supply 12 and a work piece 82 via the supply cable 76 and the work cable 80.

Specifically, current is supplied from the multi-torch power supply 12 (e.g., shared power supply 14) through the supply cable 76, into the second torch 74, across an arc from the torch 74 to the work piece 82, and back to the multi-torch power supply 12 through the work cable 80. Once again, the arc formed between the second torch 74 and the work piece 82 generally heats up the material of the work piece 82 in a focused area. In this exemplary embodiment, the second torch 74 comprises a welding torch configured to create a weld 86 as the arc heats up and liquefies the material of the work piece 82. Accordingly, the illustrated system 10 supplies wire 88 from a spool 90 in the wire feeder 22 through the supply cable 76 to the second torch 74 for insertion into the weld 86. For example, the wire 88 may be a solid wire that is suitable for a metal inert gas (MIG) welding process or a wire suitable for flux cored arc welding (FCAW). Alternatively, the welder circuit 132 could be configured for a tungsten inert gas (TIG) welding procedure. In addition, the gas cylinder 32 may supply an inert gas, such as argon for shielding gas in the tungsten inert gas (TIG) process or carbon dioxide or blends of argon with carbon dioxide, to function as a shielding gas for MIG welding. Thus, as the second torch 74 creates the weld 86, the wire 88 and gas from the gas cylinder 32 may be supplied to build up the weld material without undesirable contamination and other defects.

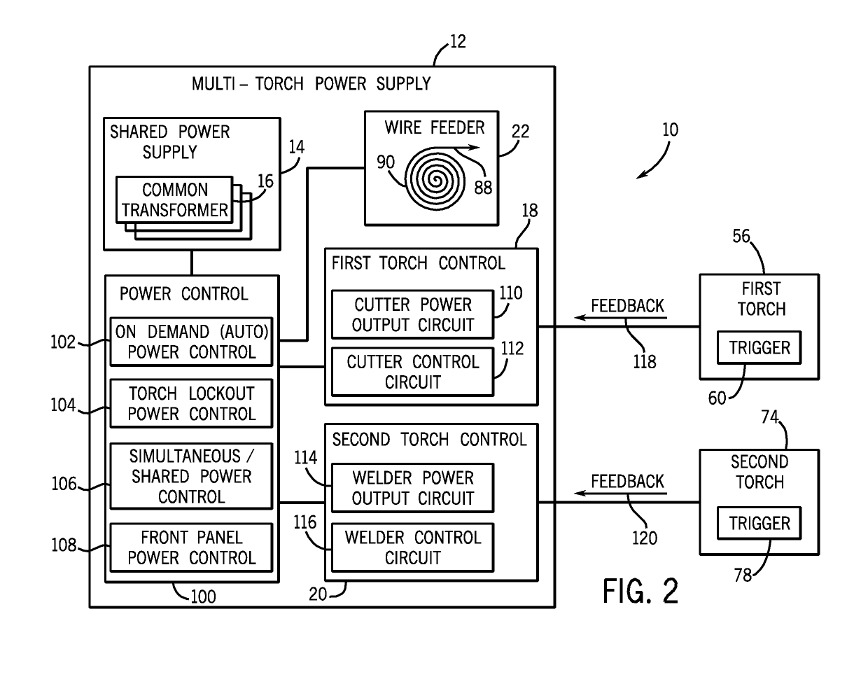

FIG. 2 is a block diagram of an exemplary embodiment of the multi-torch power supply 12 of the system 10 as illustrated in FIG. 1, further illustrating a power control 100 and circuits of the first torch control 18 and the second torch control 20. As illustrated, the power control 100 includes an on-demand (e.g., automatic) power control 102, a torch lockout power control 104, a simultaneous/shared power control 106, and a front panel power control 108. The illustrated first torch control 18 includes a cutter power output circuit 110 and a cutter control circuit 112. Similarly, the second torch control 20 includes a welder power output circuit 114 and a welder control circuit 116. These controls and circuits 102-116 are configured to cooperate with the shared power supply 14 to provide power to the first torch 56 and the second torch 74 either operating alone or in combination with one another.

For example, the on-demand power control 102 is configured to automatically provide power to either the first torch 56, or the second torch 74, or both in response to feedback 118 and 120 from the triggers 60 and 78 of the respective first and second torches 56 and 74. For example, if a user engages the trigger 60 or another suitable actuator disposed on the first torch 56, then the feedback 118 is communicated to the on-demand power control 102 which then changes the output power from an off state to an on state for the first torch 56. The on-demand power control 102 may be independent from the first torch control 18 as illustrated in FIG. 2 or the on-demand power control may be partially or entirely integrated within the first torch control 18. For example, the on-demand power control 102 may be partially or entirely integrated within the cutter power output circuit 110 of the first torch control 18.

Similarly, the on-demand power control 102 may automatically change the power state between on and off conditions with respect to the second torch 74 in response to the feedback 120 from the trigger 78 or another suitable actuator disposed on the second torch 74. Again, the on-demand power control 102 may be entirely independent from the second torch control 20, or the on-demand power control 102 may be entirely or partially integrated within the second torch control 20, for example, the welder power output circuit 114. In this manner, the first and second torches 56 and 74 may remain in a cold or un-powered state until the triggers 60 and 78 are actuated to provide the feedback 118 and 120 to the on-demand power control 102. Again, the first and second torches 56 and 74 may be operated at any time alone or in combination with one another using the shared power supply 14.

In addition, the illustrated power control 100 if FIG. 2 includes the torch lockout power control 104 to optionally lock out the first torch 56 during operation of the second torch 74, or lock out the second torch 74 during operation of the first torch 56. For example, based on the feedback 118 (e.g., indicating an engaged trigger 60) from the first torch 56, the torch lockout power control 104 may prevent power from being supplied to the second torch 74. In other words, the torch lockout power control 104 may disable the welder power output circuit 114 and/or the trigger 78 during operation of the first torch 56. Similarly, the torch lockout power control 104 may prevent operation of the first torch 56 during operation of the second torch 74 in response to the feedback 120, for example, by disabling the cutter power output circuit 110 and/or the trigger 60. This particular torch lockout power control 104 may be automatically engaged if one of the torches 56 or 74 is operated at a high power mode or otherwise requires a greater amount of the resources from the shared power supply 14.

The illustrated simultaneous/shared power control 106 may be configured to provide suitable output levels to both the first torch 56 and the second torch 74 for various cutting and welding operations. For example, the power control 106 may aid the user in balancing or adjusting the output settings of both the first torch control 18 and the second torch control 20 via the front panel power control 108. For example, a display may indicate the available output levels for the first and second torches 56 and 74 in response to various adjustments on the front panel power control 108. For example, if more power is selected for the first torch 56, then the simultaneous/shared power control 106 may indicate relatively lower output power availability for the second torch 74. The power control 106 also may control the duty cycle and other characteristics of the first and second torches 56 and 74 while being used simultaneously.

The illustrated first torch control 18 includes the cutter power output circuit 110 and the cutter control circuit 112. In certain embodiments, the cutter power output circuit 110 may include one or more of the controls 102, 104, and 106 among other power control features. The cutter power output circuit 110 also may have various settings for plasma cutting and various user inputs on the front panel power control 108. In addition, the cutter control circuit may have various settings and controls based on the selected work material, thickness, and other characteristics of the particular procedure. For example, the cutter control circuit 112 may be configured to adjust the gas flow rate, the current level, and so forth. The welder power output circuit 114 also may include one or more of the controls 102, 104, and 106. In addition, the welder power output circuit 114 may be configured to adjust the power output for a particular welding procedure, such as MIG welding, and various process variables. For example, the welder power output circuit 114 may adjust the output based on the type of material of the work piece, the work piece thickness, the size and type of the welding wire, the flow of the shielding gas, and so forth. In addition, the welder control circuit 116 may be configured to adjust the current level, the wire feed rate, the gas flow, and so forth.

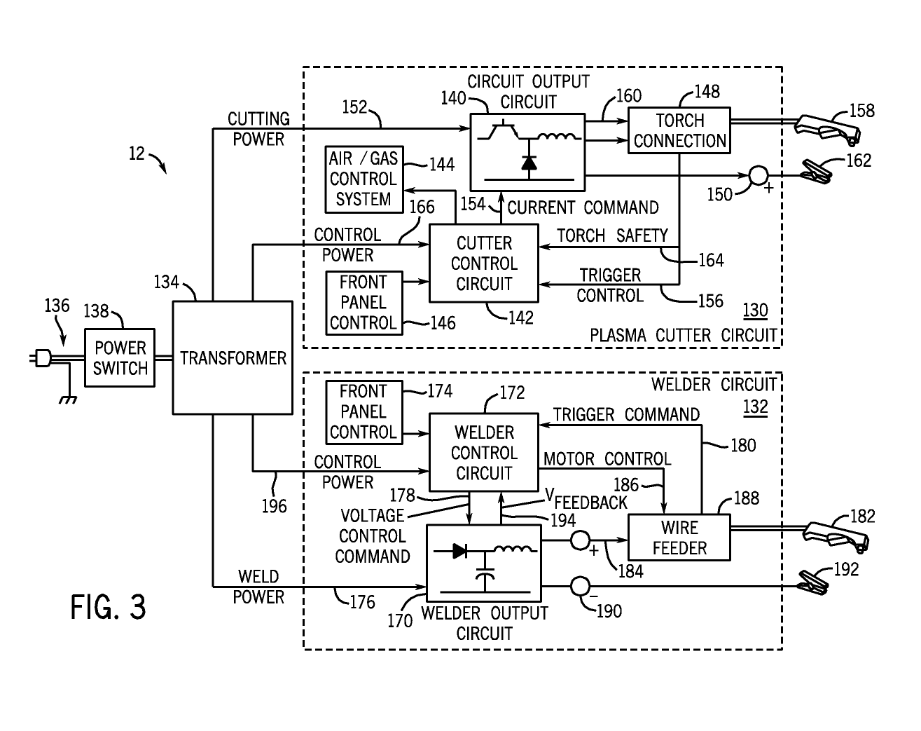

FIG. 3 is a diagram of an exemplary plasma cutter circuit 130 and a welder circuit 132 of the multi-torch power supply 12 in accordance with certain embodiments of the present technique. As illustrated, the plasma cutter circuit 130 and the welder circuit 132 are both coupled to a common transformer 134, which receives an alternating current (AC) power from a source 136, such as a power grid. The illustrated multi-torch power supply 12 includes a power switch 138 disposed between the source 136 and the transformer 134. In addition, the transformer 134 may include a primary transformer and one or more supplemental transformers in accordance with certain embodiments of the present technique. As mentioned above, in some embodiments, the transformer 134 may represent another type of common power source that is shared by both circuits 130 and 132. Alternatively, the transformer 134 may represent a plurality of power source elements, such as a plurality of windings, that may be used alone or in combination with one another for the circuits 130 and 132. For example, a first winding may be dedicated to the circuit 130, while a second winding may be dedicated to the circuit 132. However, in each of these embodiments, the circuits 130 and 132 are configured to enable on-demand power control to the respective torches.

Furthermore, the plasma cutter circuit 130 may include a cutter output circuit 140, a cutter control circuit 142, an air/gas control system 144, a front panel control 146, a torch connection 148, and a ground connection 150. For example, the cutter output circuit 140 may be configured to receive cutting power 152 from the transformer 134 in response to a current command 154 from the cutter control circuit 142. For example, the current command 154 may be provided in response to a trigger control 156 from a torch 158. In turn, the cutter output circuit 140 may provide a suitable cutting power to the torch 158 through the torch connection 148 as illustrated by arrow 160. As appreciated, a work clamp 162 also may be coupled to the connector 150 to create a closed circuit with the torch 158 and a work piece as discussed in detail above. In addition, the plasma cutter circuit 130 may include a torch safety feedback signal 164 from the torch 158 to the cutter control circuit 142. For example, the torch safety signal 164 may indicate that the torch 158 is not ready for use or various other conditions. The cutter control circuit 142 also may be configured to control the flow rate of the air/gas control system 144 based on various parameters of a plasma cutting procedure and user settings on the front panel control 146. For example, the front panel control 146 may include controls for the current level, air/gas flow rate, and so forth. In addition, the transformer 134 provides control power 166 to the cutter control circuit 142. In certain embodiments, the cutter control circuit 142 responds to the trigger control 156 from the torch 158 to provide the current command 154 to the cutter output circuit 140, thereby automatically changing a power condition of the torch 158 from an off state to an on state to enable on-demand operation of the plasma cutting torch 158. In other words, the user can pick up the torch 158, engage the trigger, and automatically receive the suitable power for plasma cutting a particular work piece.

The welder circuit 132 includes a welder output circuit 170, a welder control circuit 172, and a front panel control 174. Similar to the plasma cutter circuit 130, the welder output circuit 170 and the welder control circuit 172 are coupled to the common transformer 134. The welder output circuit 170 receives weld power 176 from the transformer 134 in response to a voltage control command 178 from the welder control circuit 172, wherein the welder control circuit 172 is responsive to a trigger command 180 from a torch 182. Thus, if a trigger of the torch 182 is actuated by a user, then the trigger command 180 is communicated to the welder control circuit 172, which then provides the voltage control command 178 to the welder output circuit 170 to initiate a welding procedure on-demand. In other words, the welder output circuit 170 provides a power output 184 to the torch 182 automatically as needed by the torch 182 as indicated by arrow 184. Upon actuation of the torch 182, the welder control circuit 172 also provides a motor control signal 186 to a wire feeder 188, which then feeds a suitable welding wire to the torch 182. In certain embodiments, the actuation of torch 182 also may trigger the welder control circuit 172 to engage a flow of shielding gas to the torch 182.

Furthermore, the welder circuit 132 includes a connector 190 for a work clamp 192, which is configured to engage a work piece to complete the closed circuit with the torch 182. In addition, the welder output circuit 170 provides voltage feedback 194 to the welder control circuit 172 to facilitate control of the welding process. Also, the welder control circuit 172 receives control power 196 from the transformer 134. Finally, the front panel control 174 enables a user to adjust and view various control parameters of the welding system. For example, the front panel control 174 may include controls for current level, voltage level, wire feed rate, shielding gas flow, and so forth. Again, the welder circuit 132 enables the torch 182 to obtain power on-demand from the transformer 134 despite the operational state of the plasma cutter circuit 130. For example, both the torches 158 and 182 may obtain the same or different levels of power from the transformer 134 via the circuits 130 and 132.

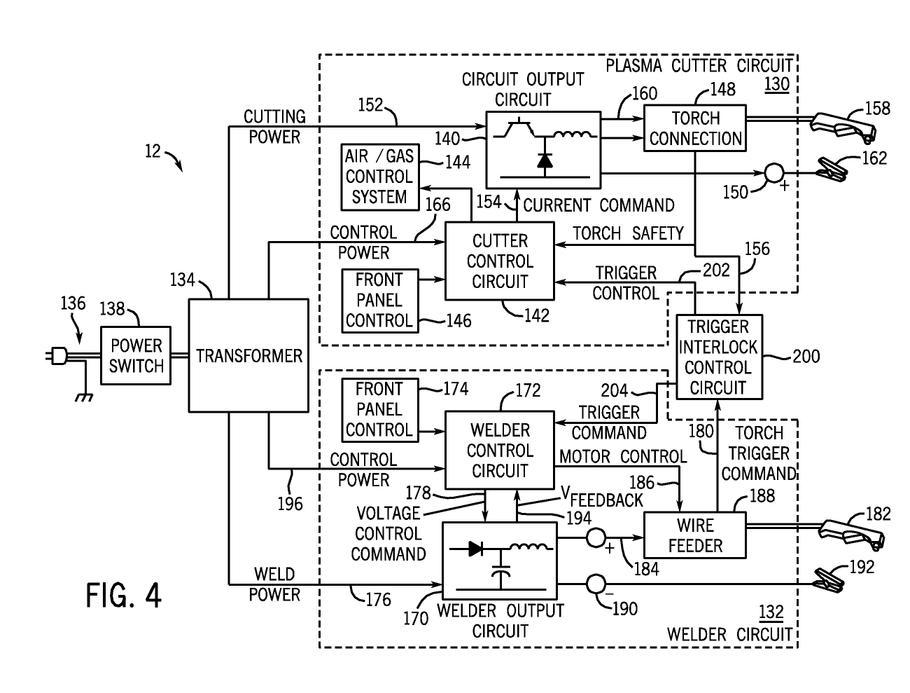

FIG. 4 is a diagram of an alternative embodiment of the multi-torch power supply 12 as illustrated in FIG. 3. Specifically, the illustrated multi-torch power supply 12 of FIG. 4 includes a trigger interlock control circuit 200 coupled to both the plasma cutter circuit 130 and the welder circuit 132. As illustrated, the trigger interlock control circuit 200 receives the torch trigger command 156 from the torch 158 as well as the torch trigger command 180 from the torch 182. As discussed in detail above with reference to FIG. 2, the trigger interlock control circuit 200 is configured to provide mutual exclusive use of the power provided by the transformer 134 by only one of the torches 158 and 182.

In other words, if a user engages the trigger on the torch 158, then the torch trigger command 156 is communicated to the trigger interlock control circuit 200. If the trigger interlock control circuit 200 determines that a torch trigger command 180 is being received (or was received) from the torch 182, then the trigger interlock control circuit 200 may prevent or disable operation of the torch 158 until operation of the torch 182 ceases. Otherwise, if the torch trigger command 180 is nonexistent or indicates that the torch 182 is not being operated, then the trigger interlock control circuit 200 may transmit a trigger control 202 to the cutter control circuit 142 to enable operation of the torch 158 as discussed in detail above with reference to FIG. 3.

Similarly, if a user engages a trigger on the torch 182, then the torch trigger command 180 is transmitted to the trigger interlock control circuit 200 for evaluation. If the trigger interlock control circuit 200 determines that the torch 158 is currently in use in view of the torch trigger command 156, then the trigger interlock control circuit 200 will prevent or disable operation of the torch 182 until operation of the torch 158 ceases. Otherwise, if the trigger interlock control circuit 200 determines that the torch 158 is not currently in use based on the torch trigger command 156, then the trigger interlock control circuit 200 may transmit a trigger command 204 to the welder control circuit 172 to enable operation of the torch 182.

In this manner, the trigger interlock control circuit 200 enables automatic control and use of the power supplied by the transformer 134 without any form of manual switching or direct access to the front panel controls 146 and 174. In other words, the mutual exclusive use of the power from the transformer 134 by one of the torches 158 or 182 is controlled on-demand or automatically via triggers directly on the respective torches 158 and 182. Thus, a user can efficiently operate either one of the torches 158 and 182 to perform the desired plasma cutting or welding operations in the work area.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a multi-torch power supply, comprising:
a first circuit configured to control output to a first electrical torch;
a second circuit configured to control output to a second electrical torch; and
a power source configured to supply power to the first and second circuits to enable operation of the first and second electrical torches, wherein the multi-torch power supply is configured to provide power to the first and second electrical torches on-demand at each respective torch.

2. The system of claim 1, wherein the first circuit comprises a cutting control circuit and the second circuit comprises a welding control circuit.

3. The system of claim 2, wherein the welding control circuit comprises a metal inert gas (MIG) welding circuit.

4. The system of claim 2, wherein the welding control circuit comprises a tungsten inert gas (TIG) welding circuit.

5. The system of claim 2, wherein the welding control circuit comprises a shielded metal arc welding (SMAW) welding circuit.

6. The system of claim 2, wherein the cutting control circuit comprises a plasma cutting circuit.

7. The system of claim 1, wherein the power source comprises a common component shared by both the first electrical torch and the second electrical torch.

8. The system of claim 1, wherein the power source comprises a first element dedicated to the first electrical torch and a second element dedicated to the second electrical torch.

9. The system of claim 1, comprising a torch lockout control configured to lockout operation of the first electrical torch during operation of the second electrical torch, and configured to lockout operation of the second electrical torch during operation of the first electrical torch.

10. The system of claim 9, wherein the torch lockout control is responsive to a trigger position of both the first electrical torch and the second electrical torch.

11. The system of claim 1, comprising a single portable chassis having the multi-torch power supply, wherein the single portable chassis comprises a pair of wheels.

12. A system, comprising:
a multi-torch power supply, comprising:
a first output configured to supply a first power to a first torch on-demand at the first torch; and
a second output configured to supply a second power to a second torch on-demand at the second torch.

13. The system of claim 12, comprising an on-demand power controller configured to control torch power in response to trigger positions of the first torch and the second torch.

14. The system of claim 12, comprising a lockout controller configured to lockout power to the first torch based on an engaged trigger position of the second torch, and configured to lockout power to the second torch based on an engaged trigger position of the first torch.

15. The system of claim 12, comprising at least one power source configured to provide power to the first output and the second output.

16. The system of claim 12, wherein the multi-torch power supply is configured to supply power to both the first output and the second output for simultaneous operation of both the first torch and the second torch.

17. The system of claim 12, comprising a plurality of user controls including welding controls and cutting controls.

18. The system of claim 12, comprising a wire feeder, or a shielding gas supply, or the first torch, or the second torch, or a combination thereof, coupled to the multi-torch power supply.

19. A system, comprising:
a first torch controller configured to receive power from a power source and to deliver a first output to a first torch on-demand at the first torch; and
a second torch controller configured to receive power from the power source and to deliver a second output to a second torch on-demand at the second torch.

20. The system of claim 19, wherein the first torch controller is configured to control power to the first torch in response to a trigger position of the first torch, and the second torch controller is configured to control power to the second torch in response to a trigger position of the second torch.

21. The system of claim 19, wherein the first and second torch controllers are configured to provide power for simultaneous and independent operation of the first torch and the second torch.
